(19) United States
(12) Patent Application Publication
(10) Pub. No.: US 2010/0077929 A1
(43) Pub. Date: Apr. 1, 2010

(54) Apparatus for Cooking Bacon and Other Flat Strips of Food

(76) Inventor: George Young, Sacramento, CA (US)

Correspondence Address: MATHEW J. TEMMERMAN, 423 E STREET, DAVIS, CA, 95616, US

(21) Appl. No.: 12/239,757

(22) Filed: Sep. 27, 2008

(51) Int. Cl. A47J 37/00; A47J 37/06

(52) U.S. Cl. 99/349; 99/425

(57) ABSTRACT

A bacon-cooking apparatus comprising a first slanted cooking surface, a second slanted cooking surface in substantially parallel planar relation with said first slanted cooking surface, wherein said second slanted cooking surface is removably attached to said first slanted surface and when attached to said first slanted surface rests on said first slanted surface to that flat strips of food placed on the first slanted surface will be appressed by the weight of the second slanted cooking surface. A third slanted cooking surface rests on said second slanted cooking surface in a fashion similar to how said second slanted cooking surface rests on said first slanted cooking surface. All cooking surfaces are slanted to provide some grease runoff into a trough beneath the lower slanted side of all cooking surfaces. The trough and device contain substantially no sharp corners that are likely to trap grease during cleanup. The device is made from a nontoxic nonleaching material capable of use in a microwave, an oven, and over an open flame.

### BACKGROUND

1. Field of the Invention

The present invention relates to cooking utensils, and more particularly to a bacon-making device for use in a variety of heat environments.

2. Background of the Invention

The United States Department of Agriculture (USDA) defines “bacon” as “the cured belly of a swine carcass”. For purposes of this patent application bacon takes the broader definition given by the USDA, which requires a separate qualification (i.e. turkey bacon, cured pork loin bacon etc.). Hence, such examples (turkey bacon and the like) will all be referred to merely as “bacon.”

There are several commonly used methods for cooking bacon. Microwaving is a simple and hands free means for cooking bacon. Bacon may also be pan fried—this means is slightly more time consuming and is the most common method used. The bacon may be placed on a broiler pan and broiled under direct heat, but this can leave the bacon slightly more bitter in taste and having a texture that can be soft and soggy. Grilling with a metal weighted device is another popular means for cooking bacon, and generally yields favorable results.

Frying, the most common means of cooking bacon, is also one of the messiest of kitchen activities. During the cooking process, grease often splatters onto the stovetop and counter and also onto persons in the vicinity of the frying bacon. The grease remaining in the frying pan is messy, hot and must generally be disposed of. The grease splattering can potentially cause severe burns or damage to the eyes, and at a minimum cause the preparer discomfort. Furthermore, bacon prepared in a frying pan is generally cooked with the heat on only one side of the pan (and thus the bacon). In this manner, a great deal of heat energy is wasted, escaping through the pan into the surrounding environment of the kitchen.

To help prevent this heat loss, and to prevent the bacon from cooking unevenly or curling at its edges, the bacon press was invented. This device, a heavy, generally metal kitchen utensil, serves as a weight placed over the bacon to flatten it during cooking. It causes the bacon to retain its natural shape and by increasing the surface area of heat application, reduces the cooking time. The bacon press is often preheated to assist with the cooking process. The weight of a typical bacon press is approximately four pounds, and they are typically made of metal, thus limiting their use to non-microwave cooking means only. A typical example of a four-pound metal bacon press is the Bayou Classic 7495 cast Iron Bacon press manufactured by Barbour International Inc. of Brandon Miss.

Although the bacon press does increase the efficiency of heat transfer, reduces splatter, and may decrease the cook time, many limitations remain. Using such devices, the bacon often comes out more well done on one side than on the other and also comes out greasy because the bacon is held in the grease that normally cooks out of the bacon. In part because of these limitations, other means for cooking bacon and devices for cooking bacon are in use.

Microwaving is one such alternative means. However, bacon that is allowed to cook flat in the microwave often becomes soggy and less palatable. There are thus a number of racks currently available and patented in the past that may be used in a microwave. There are also racks that may be used in a conventional oven or even on a grill over an open flame, but these racks cannot be used in a microwave oven. Various microwave bacon cooker devices are known for holding the bacon during cooking, including those shown by U.S. Pat. Nos. D318,206; D366,807; 4,075,102; 4,112,883; 4,214,515; 4,343,978; 4,924,049; 4,933,528 and 6,211,502. Most are not in any sort of closed container, and hence lack a means to retain the splattering grease during cooking. Finally, because metal is not feasible for use in a microwave, the vast majority of microwaveable bacon racks are made from plastic.

Plastic racks, while suitable for the microwave, are not generally suitable in other applications. The melting point for most plastics is between 250° F. and 491° F. Even Nylatron), which has a melting point of 491° F., would melt under the typical temperatures existing in the common campfire and most conventional ovens at the highest setting. Regarding hard plastics, one problem recently coming to light is the potential leaching of chemicals from certain hard plastics into other materials that are to be ingested into the human body. For instance, the ubiquitous compound Bisphenol A (BPA), a key building block in many plastic bottles, has been found to leach from plastics and resins when under high heat and high stress situations (i.e. such as when cooking). Indeed, in a 2004 test, the U.S. Centers for Disease Control (CDC) discovered at least traces of BPA in nearly all urine samples collected. Although the levels at which it was discovered were below the level that is considered safe by the U.S. Environmental Protection Agency (EPA) and the European Union's European Food Safety Authority, and although not all plastics have been found to leach chemicals, such discoveries nevertheless cause concern among consumers and have prompted a resurgence of glass for use in bottles and food storage containers.

Polytetrafluoroethylene (commonly known as Teflon-PTFE) is another logical choice. PTFE, while chemically inert and non-toxic, begins to deteriorate above temperatures of approximately 500° F. Byproducts produced during the deterioration can be lethal to birds and can cause flu-like symptoms in humans. Normally, this is not a problem in stovetop cooking because cooking fats, oils, and butter will begin to scorch and smoke at about 392° F., and meat is usually fried at between 400° F. and 450° F. For purposes of the present application, however, use over an open flame (such as when camping) is desired and anticipated. During the means to this end, there is a high probability that the present invention will be kept for some period of time over an open flame, which in a typical campfire can reach 1100-1200° F. Polytetrafluoroethylene is not the solution for a bacon cooker capable of being used in the variety of cooking situations considered by the Applicant.

U.S. Pat. No. 1,864,101 to Harry Stroup of Alamosa, Colo. discloses a bacon press comprising a hinged weighted element that pivots from an open position allowing bacon to be placed on a mesh screen to a closed position wherein said weighted elements exerts pressure on the bacon against the mesh screen. This invention lacks many of the elements in more recently disclosed bacon cooking devices.

U.S. Pat. No. 4,064,797 to Al Forzani of Vero Beach, Fla., discloses a device having two configurations for use in an oven and for facilitating the cooling of bacon. The rack comprises an angled surface with a second surface parallel to said angled surface and that rests on said angled surface, thereby appressing the bacon. Splatter is reduced and runoff grease is contained, although splatter can occur on each side of the first and second surfaces. However, this device is not adapted for a microwave, has a slope that is not optimal for cooking bacon, and does not disclose the efficiency of using a second cooking surface as the weight to ensure even cooking of bacon on a first cooking surface. Furthermore, it is not clear that force would be applied to the bacon evenly. In fact, more force would like be applied at the top of the “V” shape in the device, and without a perpendicular pressure against the bacon, the bacon cooked in this device would tend to shrivel and possibly cook unevenly. In addition to the above, the grease tray is not substantially enclosed and spillage may result, requiring extensive cleanup and possibly burning of the user of the device. Finally, the tray contains sharp angles wherein grease may become lodged, hampering cleanup after use of the device.

U.S. Pat. No. 4,173,180 to Peter Eriland of Milford Conn. discloses a bacon-cooking apparatus having a support structure handedly affixed to a base. Multiple cooking surfaces are disclosed, but the weight of additional cooking surfaces does not serve to exert pressure and improve the cooking capabilities of the other cooking surfaces.

U.S. Pat. No. 4,403,540 to Johannes Erkelenz of the Republic of Korea discloses a bacon grill comprising a housing with an inner chamber, a lid hingedly affixed thereto, and a sloped cooking surface therein for cooking bacon. Although there are many points of difference between this device and the device disclosed in the present application, the main point of difference is that the lid in this device merely serves as a means to close the contained and allow the bacon inside the device to cook. Furthermore, the device appears to have a trough with angled surfaces wherein grease would collect, does not appear to be safe for use in a microwave, and does not disclose an optimum sloped surface for pressed and cooking bacon.

U.S. Pat. No. 5,935,478, to Philip Parduhn of Edmund Okla., discloses an arcuate device having a base and lid that in a first configuration allows access to said base but in a second configuration places the lid in appressed relationship with said base, thereby exerting even pressure on bacon strips placed between the lid and the base. In this device, the lid does not double in function as a second cooking surface. Additionally, the slope for grease runoff from pressed and cooking bacon is not optimum.

U.S. Design Pat. No. d514,874 to Eckley et al. discloses a tiered bacon-cooking, grease draining device. This design patent discloses a tiered device that appears to cook bacon on a flat but uneven surface, and further comprises drain holes for the removal of bacon grease. This device does not appear to have a slant in its cooking surface, and grease, while draining through the holes present therein, would not run down a slanted surface. Further, the holes in this device would likely clogg with meat and grease runoff during cooking. Finally, Eckley et al. does not disclose a simple means for the removal of one cooking surface in order to gain access to a second cooking surface.

There are various products currently on the market that comprise a rack on which bacon is assembled for cooking. One such device from Nordicware is slanted so the Greece runs off into a depression at one end.

There are also many other specialty dishes designed specifically for microwaving bacon. The “Makn' Bacon” dish (disclosed in granted U.S. Pat. Nos. 5,552,585 and D517,874) is a simple product that elevates the bacon on poles. However, even this device leads to uneven cooking as the texture of the bacon varies greatly from one end to the other. A similar device is the Presto 05100 Microwave Bacon Cooker by Presto.

There is thus no device presently on the market, previously patented or previous disclosed that fulfills the objects of the present invention and adequately solves many of the problems associated with the prior art.

It is thus a first object of the present invention to provide an improved apparatus for cooking bacon or other similar food strips in a microwave oven, conventional oven, or over an open flame.

It is an additional object of the present invention to provide an improved apparatus for cooking bacon or other similar food strips while minimizing or preventing the mess commonly associated with conventional apparatuses and methods for cooking bacon.

It is an additional object of the present invention to provide an improved apparatus for cooking bacon or other similar food strips comprising a slope for grease drainage and a trough for grease collection, the device containing substantially no sharp angles.

It is an additional object of the present invention to provide an improved apparatus for cooking bacon or other similar food strips that contains no materials capable of leaching chemicals into the cooked food that would be injurious to the human body.

It is an additional object of the present invention to provide an improved apparatus for cooking bacon or other similar food strips that contains multiple cooking layers, with the above layers serving as a bacon press to the lower layers.

It is an additional object of the present invention to provide an improved apparatus for cooking bacon or other similar food strips that comprises a grease collection trough that has no corners in which grease may be collected.

### SUMMARY OF THE INVENTION

These and other objects of the present invention, such as addressing issues of (a) providing a transparent cooking device so the doneness of the food can be easily observed, (b) providing dual weighted cooking surfaces, (c) providing a complete splatter guard in all areas, (d) providing an optimum cooking angle for optimum fat drainage so as to improve flavor of the meat cooked, and (e) providing a bacon press with seprateable cooking surfaces that can by themselves be used as a transparent bacon press, are achieved by providing a bacon-cooking apparatus comprising a first slanted cooking surface, a second slanted cooking surface in substantially parallel planar relation with said first slanted cooking surface, wherein said second slanted cooking surface is removably attached to said first slanted surface and when attached to said first slanted surface rests on said first slanted surface to that flat strips of food placed on the first slanted surface will be appressed by the weight of the second slanted cooking surface. A third slanted cooking surface rests on said second slanted cooking surface in a fashion similar to how said second slanted cooking surface rests on said first slanted cooking surface. All cooking surfaces are slanted to provide some grease runoff into a trough beneath the lower slanted side of all cooking surfaces. The trough and device contain substantially no sharp corners that are likely to trap grease during cleanup. The device is made from a nontoxic, nonleaching material capable of use in a microwave, an oven, and over an open flame.

### BRIEF DESCRIPTION OF THE DRAWINGS

The foregoing aspects and many of the attendant advantages of the invention will become more readily appreciated as the same becomes better understood by reference to the following detailed description, when taken in conjunction with the accompanying drawings, wherein:

FIG. 1 depicts a perspective view of the apparatus for cooking bacon according to a preferred embodiment of the present invention;

FIG. 2 depicts a top planar view of the apparatus for cooking bacon according to a preferred embodiment of the present invention, wherein a cross sectional line taken from point 7-7 is shown;

FIG. 3 depicts a right side planar view of the apparatus for cooking bacon according to a preferred embodiment of the present invention, wherein cross sectional lines taken from point 8-8 and point 9-9 are shown;

FIG. 4 depicts a bottom planar view of the apparatus for cooking bacon according to a preferred embodiment of the present invention;

FIG. 5 depicts a front planar view of the apparatus for cooking bacon according to a preferred embodiment of the present invention;

FIG. 6 depicts a rear planar view of the apparatus for cooking bacon according to a preferred embodiment of the present invention;

FIG. 7 depicts a cross sectional view taken from FIG. 2, wherein the center portion of the image has been cut away to allow the depiction of greater detail;

FIG. 8 depicts a cutaway cross sectional view taken from FIG. 3, wherein only the right side of the device is depicted; and

FIG. 9 depicts a cutaway cross sectional view taken from FIG. 3, wherein only the right side of the device is depicted.

### DETAILED DESCRIPTION OF THE INVENTION

The following description is presented to enable a person of ordinary skill in the art to make and use various aspects and examples of the present invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

The bacon cooking device of the present invention eliminates much of the mess associated with cooking bacon, cooks multiple levels of bacon evenly and safely, uses the weight from an upper cooking level to apply pressure to a lower cooking level, may be used in a variety of heating environments, and traps the grease runoff from the bacon in an easy-to-clean trough.

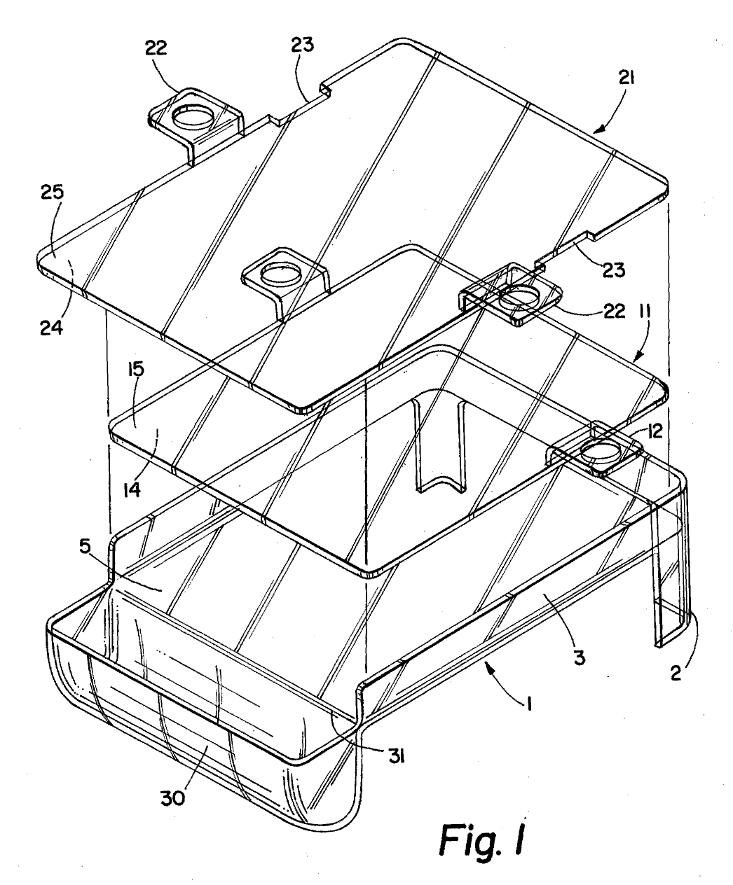

With reference to the drawings, specifically first to FIG. 1, the device disclosed herein provides a base 1 having a sidewall 3 rising up from the base on at least three sides. Sidewall 3 also serves as a splatter guard. On the open side, a lip 31 leads to a trough 30. In use the trough 30 will catch bacon grease, and thus to ease the subsequent cleaning, trough 30 contains no sharp corners where the grease may become lodged. Thus, in a preferred embodiment trough 30 comprises only flat portions and curved portions, with no sharp angles between flat portions. Base 1 further comprises a first slanted cooking surface 5. First slanted cooking surface 5 (and for that matter all cooking surface) in a preferred embodiment exhibits a slant of approximately ⅛ inch per foot downwards towards lip 31 and trough 30. Being slightly off from horizontal to the ground allows any grease runoff to flow downwards. Other slopes from 1/16 inch per foot up to 1 inch per foot are considered and disclosed, however, the slope of ⅛ inch per foot is preferred as it strikes the ideal balance between allowing grease to drain away yet not allowing the grease to drain so quickly that it does impart its flavor to the cooking food. If the slope is too great, the food will be dry because the grease runs off too quickly. If the slope is too little, then not enough grease will run off, and more will end up in the food to be consumed.

Two legs 2 support one end of base 1 while trough 30 supports the other end of base 1. As shown best in FIG. 3, the trough 30 is preferably slightly shorter then legs 2, thereby creating the aforementioned slope.

In a preferred embodiment, there are three layers to the bacon-cooking device, and four cooking surfaces wherein each layer of food to be cooked has a cooking surface both above and below it. The first layer for cooking is first slanted cooking surface 5, previously described. A second slanted cooking surface 11 removably rests on first slanted cooking surface 5. Second slanted cooking surface 11 is sized to nest tightly within the confines of sidewall 3, and due to its flat shape, rests in a plane parallel to the first slanted cooking surface 5 plane, albeit directly above. The second slanted cooking surface has an upper side and a lower side, both are cooking surfaces. The upper side is referred to as second slanted cooking surface upper side 15 and the lower side is referred to as second slanted cooking surface lower side 14. The lower side 14 is the only side that comes into contact with first slanted cooking surface 5. Slices of food placed between the lower side 14 and first slanted cooking surface 5 will thus be placed between two cooking surfaces. Second slanted cooking surface 11 further comprises 2 handholds, each referred to as first handhold 12, that rise up for easy gripping by the user of the device.

The third layer of the device is referred to as third slanted cooking surface 21. Like base 1, third slanted cooking surface 21 contains only one cooking surface. The upper side is referred to as lid 25 and in a preferred embodiment is not a cooking surface. (In other embodiments in which additional cooking layers are added, the upper side does serve as a cooking surface). The lower side is referred to as third slant cooking surface lower side 24. The lower side 24 is the only side that comes into contact with slanted cooking surface upper side 15. Slices of food placed between the lower side 24 and second slanted cooking surface upper side 15 will thus be placed between two cooking surfaces. Third slanted cooking surface 21 further comprises 2 handholds, each referred to as second handhold 22, that rise up for easy gripping by the user of the device. Furthermore, notch 23 provides a space for first handhold 12 to extend above and beyond the third slanted cooking surface 21. Similar to said second slanted cooking surface 11, third slanted cooking surface 21 is removably nested within the confines of sidewall 3, and due to its flat shape, rests in a plane parallel to the first slanted cooking surface 5 plane, albeit directly above.

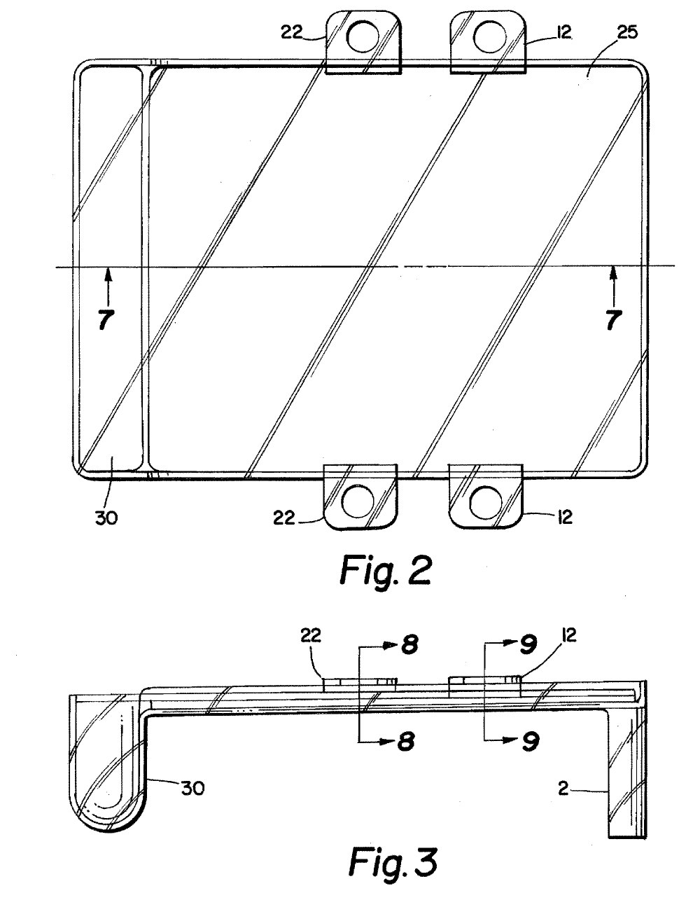

The nesting configuration and planar alignment of the cooking surfaces is shown best in FIG. 2. Due to the layers being directly over one another, only lid 25 is labeled on FIG. 2. In actuality, the layers are preferably made of heat resistant glass, and thus are substantially transparent, allowing the viewer to see through each cooking surface and all the way through the device. In an alternative embodiment of the invention, and not depicted in the Figures, base 1 is slightly thicker than the levels above it. This increase in thickness smoothes out the variations from an unshown heat source underneath base 1 that serves to warm the base and thus the food between the cooking surfaces. A thicker base 1 acts as a better heat modulator and regulator for better and more-even heat distribution when used in an oven or outdoors. The increased thickness has little to no effect when the device is used in microwave, but at the same time does not hinder the usefulness of the device in a microwave in any way.

Returning to FIG. 2, the relationship between first handholds 12 and second handholds 22 is depicted. As shown here, first handhold 12 rises through and above notch 23 (not labeled in this Figure) to as to be aligned with second handhold 22. This is alignment is shown again in FIG. 3, where the extended length of first handhold 12 relative to second handhold 22 is apparent.

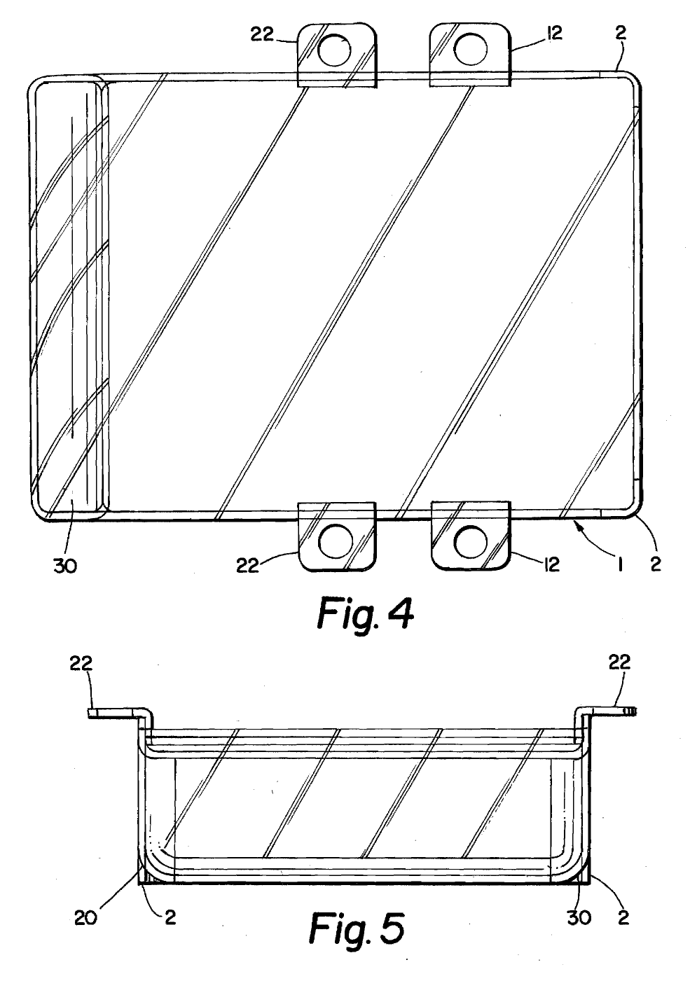

Turning now to FIG. 4, the device is depicted in planar view from underneath. Again, base 1 is depicted and the legs 2 extend toward the viewer as shown. The relative positions of first handhold 12 and second handhold 22 are shown again as well. Finally, the underside of trough 30 is depicted wherein the curved nature (no sharp corners) of the trough are apparent.

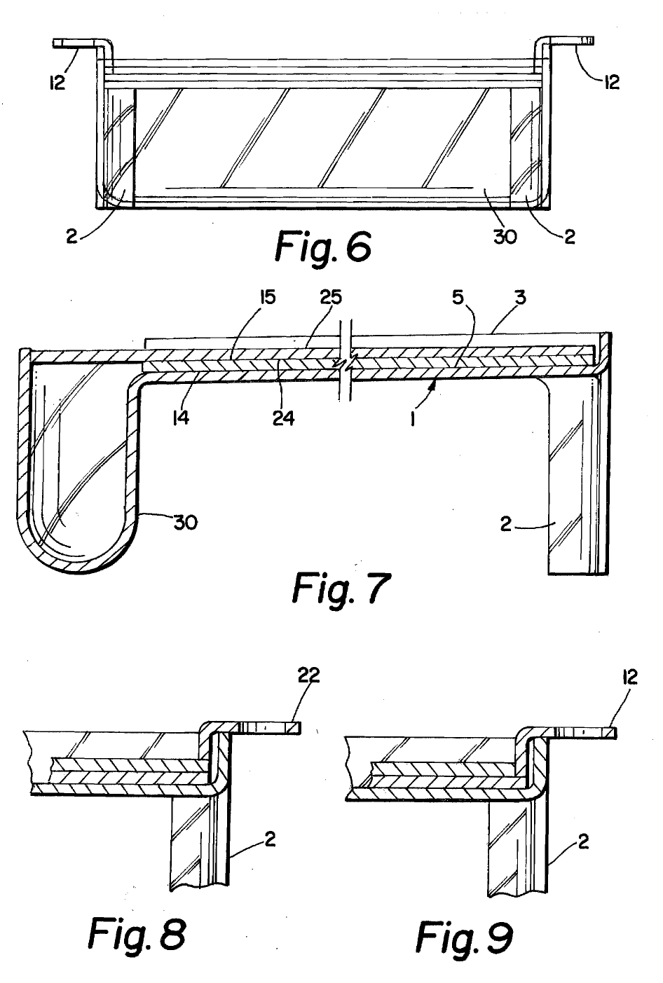

FIG. 5 also shows the rounded nature of trough 20 as looking at the trough from a front planar perspective. Behind the rounded bottom of trough 20 in this Figure, the legs 2 are visible. In FIG. 6, a rear planar perspective, legs 2 are seen in front of trough 20.

FIG. 7 is a cutaway view taken along cutline 7-7 in FIG. 2. FIG. 7 shows the curved nature of trough 30, as well as the position of legs 2. Less obvious is a detailed depiction of the cooking surfaces and their relation to sidewall 3. The highest component in FIG. 7 is sidewall 3. Sidewall 3 extends above all cooking surfaces so as to retain any grease runoff and direct it to trough 30. Base 1 is the bottom level, the underside of which (not labeled) is not a cooking surface. The upper side of base 1 is first slanted cooking surface 5. Second slanted cooking surface lower side 14 appresses against first slanted cooking surface 5 and any food placed therebetween. Opposite from second slanted cooking surface lower side 14 is second slanted cooking surface upper side 15. Third slanted cooking surface lower side 24 appresses against second slanted cooking surface upper side 15 and any food placed therebetween. Opposite third slanted cooking surface lower side 14 is lid 25, which extends over the trough in order to retain the grease runoff. In an alternative embodiment of the invention (not shown) sidewall 3 as shown in FIG. 7 extends beyond the end of all cooking surface to a position over trough 30 so as to create a “splatter guard” against any projectiles that may leave the device and later require cleanup of the cooking device in which the device is placed. In this alternative embodiment, the contents of trough 30 are substantially sealed by lid 25 on top and sidewall 3 on each side.

FIGS. 8 and 9 are cutaway views taken along the corresponding cutlines in FIG. 3. FIG. 8 is a cross section taken through first handhold 12 while FIG. 9 is a cross section taken through second handhold 22. In FIG. 9, first handhold 12 extends through notch 23 (not labeled) to attach to second slanted cooking surface 11. Turning now to FIG. 8, second handhold 22 connects directly to third slanted cooking surface 21.

The device disclosed herein may be constructed from several different materials, but in a preferred embodiment the device is constructed from a glass-like material that presents little to no risk of leaching chemicals that may be injurious to the human body. The device may thus be made entirely from tempered glass or other similar toughened glass and glass-like materials such as borosilicate glass and fused quartz. In general, the class of glass-like materials halving a low coefficient of thermal expansion (i.e. wherein coefficient of volumetric thermal expansion β at 20° C. is <=15×10⁻⁶/K, or more preferably is <=10×10⁻⁶/K) would be adequate since they will not break or shatter when subjected to the high heat levels required to cook meat._ In addition to their increased strength, borosilicate glass, fused quartz and tempered glass have several advantages against plastics and polytetrafluoroethylene in that they are relatively inert and more heat resistant. As an example regarding the heat resistance of the material, borosilicate glass begins to soften at 1461° F. while tempered glass softens at 1510° F., both well above even the hottest campfires at 1200° F. Because these materials are substantially clear, the user of the device will be able to look through each cooking surface to observe the cooking of the food placed in the device. The point at which the food is cooked to an ideal level can thus be determined without opening the device or disturbing the food in any way.

In an additional alternative embodiment the base, while still made of a toughened glass or glass-like material, is made from a tinted variant of the material and will not be completely clear like layers above it. This is for aesthetic purposes only.

In use, the device comprises two areas in which bacon or other strips of food may be cooked. The weight of the third slanted cooking surface 21 appresses the food between second slanted cooking surface upper side 15 and third slanted cooking surface lower side 24. Similarly, the weight of both third slanted cooking surface 21 and second slanted cooking surface 11 appresses the food between first slanted cooking surface 5 and second slanted cooking surface lower side 14. In all, there are four cooking surfaces for two areas in which bacon or other strips of food may be cooked. In an alternative embodiment of the invention, additional cooking surfaces are provided. In this alternative embodiment, additional slanted cooking surfaces are placed over those shown in the Figures. The additional cooking surfaces comprise notches and handholds to allow their easy removal similarly to that described in the preferred embodiment.

To cook with the device, the user simply loads bacon or other strips of food between the cooking layers, and places the device either in a microwave, in an oven (gas or electric) or over an open flame such as a grill or campfire. Regarding the use over an open flame, in a preferred embodiment the device is first placed in a metal container or on a rack or some flat surface (not shown) before being placed over the open flame. Regardless as to whether the device is used directly over an open flame or first placed in a metal rack, oven gloves may be necessary for manipulation of the device once it has reached full cooking temperature.

The gradient of the slope controls the rate of grease runoff. The optimum gradient of ⅛ inch per foot allows much of the grease produced to run downwards toward the trough-end of the device. At the end of the slope, the grease exits the area between the cooking surfaces and falls into trough 30 for grease collection.

If bacon is cooked in the device, the bacon will be cooking evenly and exhibit reduced shrinkage and curling. This is due to the weight of the layers above each cooking layer. The thickness of the glass is important because this weight is what keeps the bacon pressed. If the glass is too thin (and hence does not weigh enough), then it will not exert enough pressure on the bacon to ensure the bacon cooks evenly. This serves to keep the bacon straight and aesthetically pleasing, reduces bacon curl and reduces shrinkage of the bacon. The Applicant has determined that regardless of the thickness of the bacon to be cooked, all bacon cooks evenly and with superior palatability.

In use, minimal sharp angles on the device promote ease of cleaning as it will be difficult for grease to find an area that may not simply be wiped clean by the user after cooking. Most conventional bacon cooking devices have corners in which grease and drippings collect, making for tedious, time-consuming cleanup. In the present application, the trough itself contains no hard angles.

While the device described above has been described substantially with regard to bacon as an exemplary food to be cooked in the device, in actuality many other thin food items may be cooked in the device with equal ease. Additionally, the cooking surfaces can be removed from the device completely and used individually directly on the grill as a transparent bacon press.

With respect to the above description then, it is to be realized that material disclosed in the applicant's drawings and description may be modified in certain ways while still producing the same result claimed by the applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

I claim:

1. A meat cooker adapted for suspending at least two levels of meat product during cooking, comprising:
a. a first slanted cooking surface having at least two sidewall splatter guards and at least two legs;
b. a second slanted cooking surface in substantially planar relation with said first slanted cooking surface, and having a second slanted cooking surface lower side adjacent to said first slanted cooking surface and a second slanted cooking surface upper side; and
c. a third slanted cooking surface in substantially planar relation with said second slanted cooking surface, and having a third slanted cooking surface lower side adjacent to said second slanted cooking surface and a lid.

2. The meat cooking according to claim 1 wherein said second slanted cooking surface further comprises a first handhold that extends above the plane of said third slanted cooking surface and wherein said third slanted cooking surface comprises a second handhold that also extends above the plane of said third slanted cooking surface.

3. The meat cooker according to claim 2 wherein said first slanted cooking surface has a lower end and wherein a grease receptacle is positioned beneath the lower end.

4. The meat cooker according to claim 3 wherein said first slanted cooking surface is thicker than said second slanted cooking surface and said third slanted cooking surface.

5. The meat cooker according to claim 3 wherein said cooking surfaces comprise glass having a low coefficient of thermal expansion.

6. The meat cooker according to claim 5 wherein said cooking surfaces comprise borosilicate glass.

7. The meat cooker according to claim 5 wherein said cooking surface consists of glass having a low coefficient of thermal expansion.

8. The meat cooker according to claim 5 wherein each said cooking surface is substantially transparent.

9. The meat cooker according to claim 5 wherein said grease receptacle has no sharp angles.

10. The meat cooker according to claim 9 wherein said meat cooker contains substantially no sharp angles.

11. The meat cooker according to claim 10 wherein said lid extends to a position above said grease receptacle, thereby acting as a lid splatter guard for said grease receptacle.

12. A press adapted for suspending at least two levels of meat product during cooking, comprising:
a. a slanted base comprising legs and a slanted base cooking surface;
b. a middle slanted cooking surface, said middle slanted cooking surface comprising a middle slanted cooking surface first side in substantially planar contact with said slanted base cooking surface and a middle slanted cooking surface second side opposite said middle slanted cooking surface first side; and
c. an upper slanted cooking surface, said upper slanted cooking surface comprising an upper slanted cooking surface first side in substantially planar contact with said middle slanted cooking surface second side.

13. The press according to claim 12 wherein said middle slanted cooking surface further comprises a first handhold that extends above the plane of said upper slanted cooking surface and wherein said upper slanted cooking surface comprises a second handhold that also extends above the plane of said upper slanted cooking surface.

14. The press according to claim 13 further comprising a trough.

15. The press according to claim 14 wherein said slanted base cooking surface has a lower end and wherein a grease receptacle is positioned beneath the lower end.

16. The press according to claim 14 wherein said cooking surfaces and said grease receptacle comprise glass having a low coefficient of thermal expansion.

17. The meat cooker according to claim 14 wherein said cooking surfaces and said grease receptacle comprise borosilicate glass.

18. The meat cooker according to claim 15 wherein said slope exhibits a downward gradient of approximately ⅛ inch per foot.

19. The meat cooker according to claim 18 wherein each said cooking surface is substantially transparent.

20. The meat cooker according to claim 19 wherein said press comprises substantially no sharp angles and wherein said cooking surface extends to a position above said grease receptacle, substantially enclosing said grease receptacle.
